(19) United States
(12) Patent Application Publication
(10) Pub. No.: US 2026/0175809 A1
(43) Pub. Date: Jun. 25, 2026

(54) INFLATABLE PROTECTIVE DEVICE, WEARABLE PROTECTIVE DEVICE COMPRISING SUCH AN INFLATABLE PROTECTIVE DEVICE AND METHOD FOR EFFECTIVELY DEFLATING SUCH AN INFLATABLE PROTECTIVE DEVICE AFTER INFLATION

(71) Applicant: ALPINESTARS RESEARCH S.P.A., Maser (TV) (IT)

(72) Inventors: Giovanni MAZZAROLO, Coste di Maser (TV) (IT); Riccardo FAGGIAN, Dolo (VE) (IT)

(21) Appl. No.: 19/125,917

(22) PCT Filed: Nov. 2, 2023
(86) PCT No.: PCT/IB2023/061031

§ 371 Date: Apr. 30, 2025

(30) Foreign Application Priority Data
Nov. 4, 2022 (IT) 102022000022623

(51) Int. Cl. B60R 21/213; B60R 21/207; B60R 21/2165; B60R 21/217; B60R 21/231; B60R 21/232; B60R 21/233; B60R 21/26

(52) U.S. Cl. CPC B60R 21/213; B60R 21/207; B60R 21/2165; B60R 21/217; B60R 21/231; B60R 21/23138; B60R 21/232; B60R 21/233; B60R 21/26

(57) ABSTRACT

An inflatable protective device including an inflatable member, an inflator device designed to be coupled to the inflatable member for inflating the inflatable member, and at least one protection sleeve. The at least one protection sleeve has an operative portion extending inside the inflatable member for putting the at least one protection sleeve in fluid communication with the inflatable member. The at least one protection sleeve includes stiffening means arranged at the operative portion for maintaining in fluid communication the at least one protection sleeve with the inflatable member. Also, a wearable protective device including an inflatable protective device and a method for effectively deflating such an inflatable protective device after inflation.

The present invention relates to an inflatable protective device. In particular, the present invention refers, even if in a non-exclusive way, to an inflatable protective device suitable to protect a user from impacts and/or falls during a sporting and/or working activity, like for example motorcycling, cycling, skiing and others.

Moreover, the present invention relates to a wearable protective device comprising such an inflatable protective device and to a method for effectively deflating such an inflatable protective device after inflation.

Generally, the inflatable protective devices designed to protect a user from impacts and/or falls are arranged inside a protective garment or a protective harness.

In detail, the inflatable protective device comprises an inflatable bag connected to an inflation device. The inflatable bag is in fluid communication with the inflation device, like for example a gas cartridge, which is adapted to introduce into the inflatable bag a predefined quantity of an inflation fluid, like for example compressed gas.

In this way, the inflatable bag can expand and thus it can provide cushioning against impacts and/or falls.

The releasing of the inflation fluid inside the inflatable bag can be controlled by a mechanical and/or electronic activation system.

The gas cartridges usually consist in a cylindrical housing having a first end connected to the inflatable bag.

The connection of the gas cartridge to the inflatable bag can be carried out by directly clamping an end of the cartridge inside an opening end of the inflatable bag. Alternatively, the end of the gas cartridge can be provided with an external thread suitable for being screwed inside a corresponding thread of a cap, arranged at the opening end of the inflatable bag.

As another option, the end of the gas cartridge can be connected to the inflatable bag by means of a bayonet mount, wherein the male element is provided at the end of the gas cartridge and a female receptor is provided at a cap arranged at the opening end of the inflatable bag.

Due to the need for a small footprint, the gas cartridge must have a small size, whereby the inflation fluid is stored inside it under high pressure.

At the same time, when a dangerous situation for the user is detected by the activation mechanism, the inflation of the inflatable bag needs to be as quick as possible so that the bag can rapidly reach the inflated status for providing an improved protection to the user.

The needs to have an inflation fluid stored under high pressure inside the gas cartridge and to obtain a quick inflation of the inflatable bag determine that a high flow rate of the inflation fluid comes out from the gas cartridge when the latter is triggered. As a matter of fact, most of the inflation fluid comes out from the corresponding gas cartridge in a time of the order of a few tenths of milliseconds or even lower.

This occurrence produces high stresses at the connection area between the gas cartridge and the inflatable bag, with a not negligible risk of damages or ruptures in the inflatable bag.

To assure the integrity of the inflatable bag during the inflation it is known to arrange a protection element, a so-called “protection sleeve”, between the connecting end of the gas cartridge and the opening end of the inflatable bag.

Such a protection sleeve has generally a tubular shape and it is made of a flexible material so as to be flattened in use and not to create discomfort to the user.

Preferably, the protection sleeve is made of fabric material, advantageously of the same material of the inflatable bag.

Generally, the protection sleeve consists of two fabric sheets sewn together at the edges, so as to obtain a tubular shape.

The use of a protection sleeve is appreciated and recommended, since it protects the bag against ruptures due to a sudden inflation and thus it permits the bag to be reused, namely to be inflated in subsequent times, if the bag has not undergone damages, like tearing or punctures. This offers many advantages.

As a matter of fact, the possibility to reuse the inflatable bag after inflation reduces, for example, the time in which the garment coupled to the inflatable protective device is not available for the user. Other advantages are the reduction of the airbag wastes, of the costs related to the spare parts supply and of the related customer service organization.

Unless the inflator device is provided with more than one inflation charge, the exhaust inflator device needs to be replaced with a new one after every deployment.

However, inflatable protective devices provided with the protection sleeves still have a further drawback.

As a matter of fact, in recent times, an aim of the various manufacturers of the inflatable protective devices is to permit that the replacement of the inflator device is carried out directly by the final user, instead of being performed by specialized personnel.

To achieve such an aim, the connection between the inflator device and the inflatable member has been simplified. Moreover, the inflator device has been made easily reachable by the user.

However, either if the replacement of the inflator device is carried out by the final user or by specialized staff, it is necessary that the inflatable bag is in a completely deflated condition after the decoupling of the inflator device.

As a matter of fact, if the inflatable bag is not completely deflated after inflation, there is the risk that during an eventual subsequent inflation the internal pressure reaches a pressure value different from that desired and calculated during the development phase, in view of the protection to be obtained and the strength of the bag.

Moreover, the complete deflation of the inflatable bag is also useful and desired when the inflatable protection device is inserted or integrated inside a garment, so as to avoid that the user feels discomfort upon wearing the garment. As a matter of fact, in case the inflatable bag is not completely deflated, the user can feel movement limitations or an unpleasant warm feeling due to the thermic insulation which can be provided by an inflated bag.

Furthermore, the complete deflation of the inflatable bag is also desired in case the protective device is coupled to an undergarment designed to be used in combination with an outer protective garment. If the inflatable bag is not completely deflated, the additional volume thereof can prevent the undergarment to be properly worn under the outer protective garment.

However, even if the inflatable bag is made of a breathable material or is provided with a deflation valve, the complete deflation of the bag in some cases is not easy to reach.

As a matter of fact, during deflation, the internal pressure of the bag decreases until it reaches a sort of equilibrium with the external environment. In such a situation the inflatable bag is not completely empty.

As a matter of fact, even if the inflator device is decoupled from the inflatable bag, a small quantity of the inflation fluid remains still blocked inside the bag.

Moreover, such a deflation is hindered by the presence of the protection sleeve.

As a matter of fact, after the inflation, the protection sleeve due to its shape and to its flexibility can close or collapse on itself, acting as a non-return valve and preventing thus the complete deflation of the bag.

Such a problem still exists even if the deflation of the bag is encouraged by manual pressing on the bag. As a matter of fact, the gas pressure is distributed uniformly inside the bag, keeping it swollen in all its parts. At the same time the protection sleeve is completely surrounded by such a pressure and thus without an external force keeping the terminal end of the protection sleeve open, the latter can still block the exit of the gas.

It should also be noted that, in case the inflatable bag is connected to the gas cartridge by means of a cap, the deflation of the bag can be further hindered since the only fluid connection between the external environment and the inside of the bag is the one or more channels provided in the cap.

Furthermore, if the protection sleeve is made of two fabric sheets sewn together along the edges, the closing of the sleeve is more likely since the shape of the sleeve itself tends to keep the two sheets close to each other.

Consequently, in order to have the same level of safety obtainable during the first inflation, to date it is preferable and preferred that the replacement of the inflator device is carried out by specialized personnel able to assure that the deflation of the inflatable bag is complete.

The object of the present invention is to provide an inflatable protective device which solves at least partly the above mentioned drawbacks.

In particular, an aim of the present invention is to provide an inflatable protective device with an inflator device which can be easily replaced after activation even by not-specialized personnel.

Another aim of the present invention is to provide an inflatable protective device for which, after activation, a complete and quick deflation of the inflatable bag during the replacement of the inflator device can be assured.

A further aim of the present invention is to provide an inflatable protective device which permits a quick and effective deflation of the inflatable bag during the replacement of the inflator device, without affecting the inflation phase or the connection between the inflatable bag and the inflator device.

Another aim of the present invention is to provide a wearable protective device with an inflatable protective device suitable for assuring a high comfort to the user even after the replacement of the inflator device.

Lastly, an aim of the present invention is to provide a method for effectively deflating an inflatable protective device during the replacement step of the inflator device after activation.

These and other objects and aims are achieved by an inflatable protective device according to claim 1, by a wearable protective device according to claim 24 and by a method according to claim 25.

The advantages and the characteristic features of the invention will appear more clearly from the following description of preferred, but not exclusive, embodiments of the invention with reference to the accompanying figures in which:

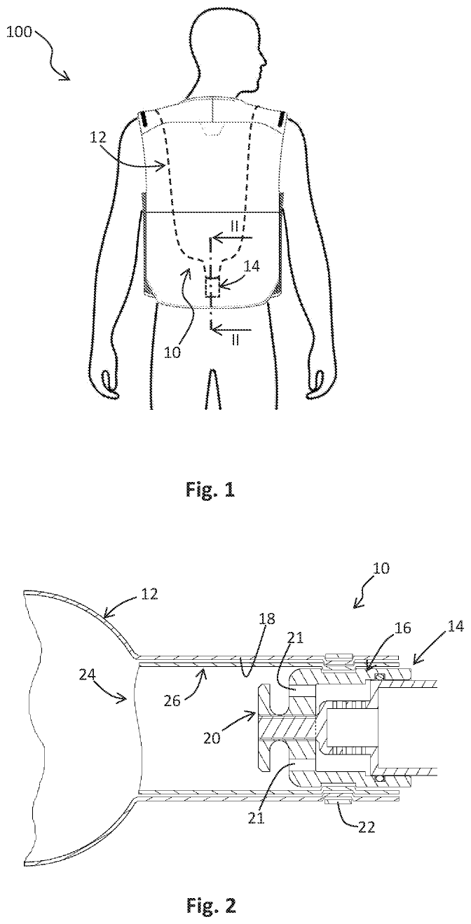

FIG. 1 shows a rear view of a wearable protective device according to the present invention;

FIG. 2 is a simplified sectional view taken along the line II-II of FIG. 1;

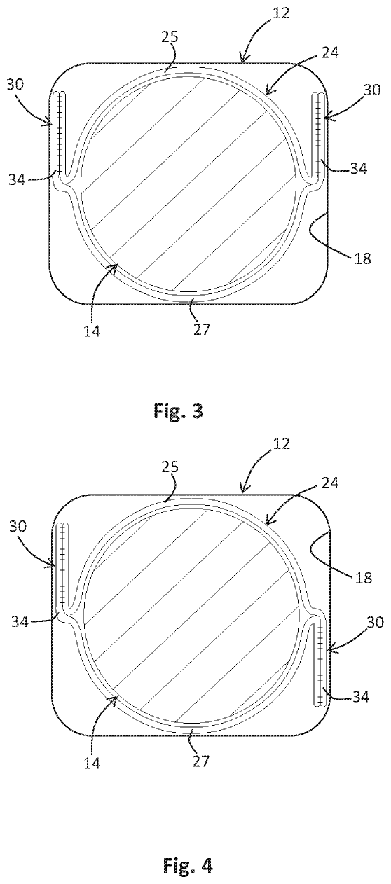

FIGS. 3 and 4 are cross-sectional views showing the mutual positioning between the inflator device, the protection sleeve and the inflatable member according to two different embodiments of the present invention;

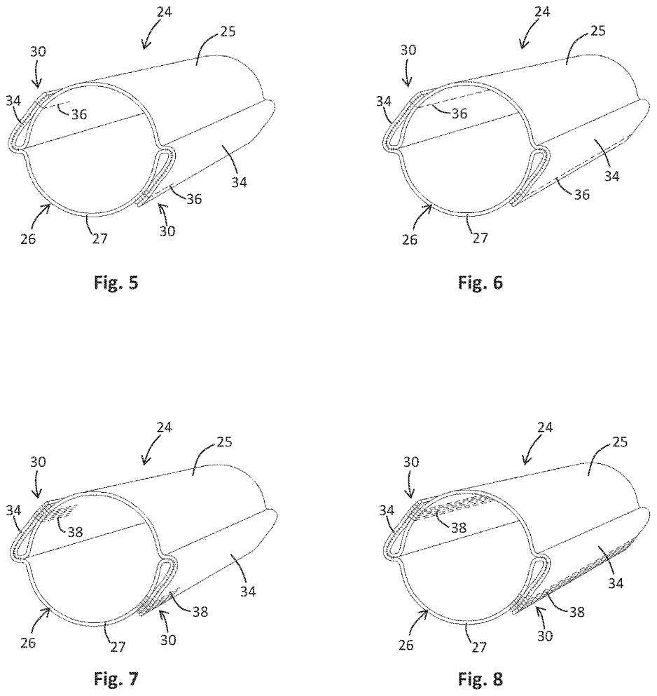

FIGS. 5-15 are schematic perspective views of the protection sleeve according to different embodiments of the present invention;

FIGS. 16-17 are longitudinal section views of two further different embodiments of the protection sleeve according to the present invention;

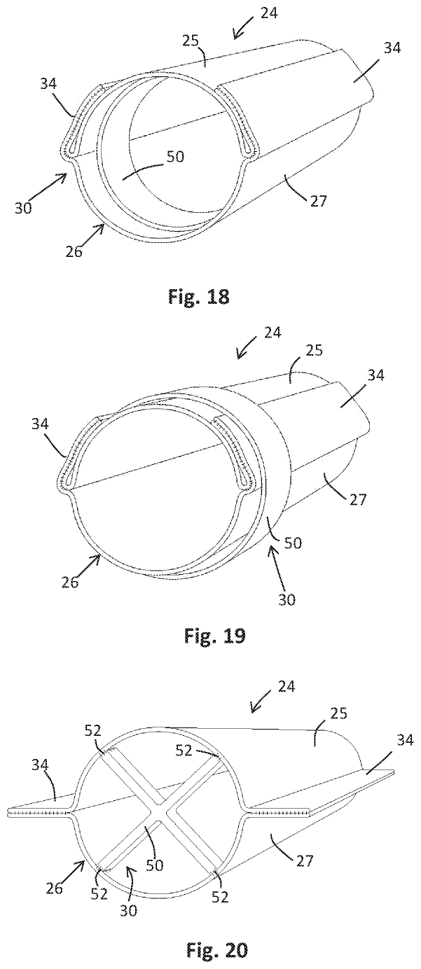

FIGS. 18-20 and 22 are schematic perspective views of alternatively embodiments of the protection sleeve according to the present invention;

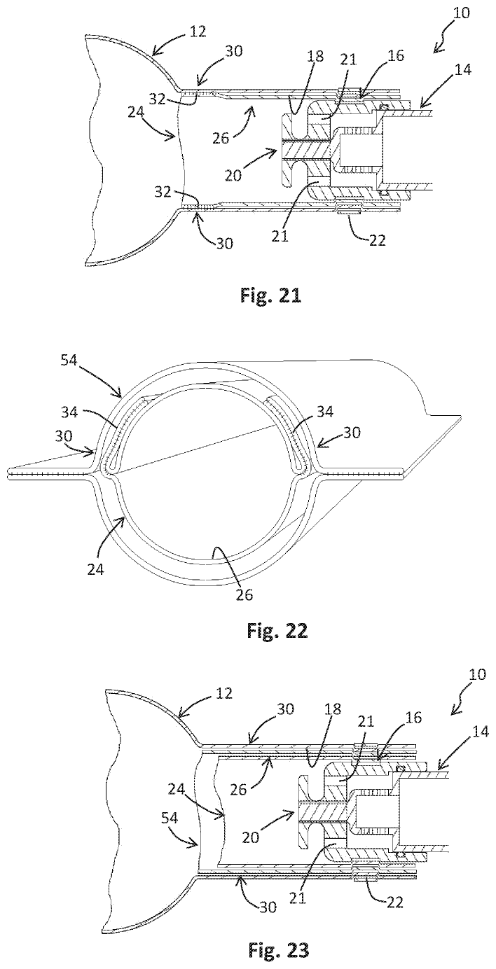

FIGS. 21 and 23 are views similar to FIG. 2, but related to different embodiments of the present invention;

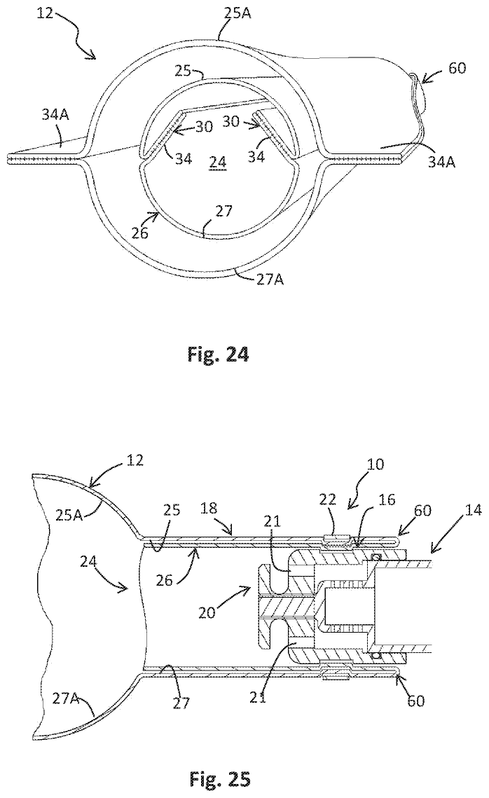

FIG. 24 is a schematic perspective view similar to those of FIGS. 5-15, but related to a different embodiment;

FIG. 25 is a longitudinal section view of the embodiment of FIG. 24.

With reference to the enclosed figures, an example of an inflatable protective device, according to the present invention, is indicated in its whole by the reference 10.

As shown in FIG. 1, the inflatable protective device 10 is suitable for being coupled or integrated with a wearable protective device 100. In particular, the inflatable protective device 10 can be coupled or integrated with protective garment 100, like for example a jacket or a vest. Alternatively, the inflatable protective device 10 can be coupled to an undergarment suitable for being used in combination with an outer protective garment.

In a further embodiment, the inflatable protective device 10 can be coupled to a harness designed to be worn on top or under a further garment or it can be integrated in a protection element, like for example a helmet.

Advantageously, the inflatable protective device 10 is designed for protecting the body of the user from injuries that result from impacts and falls.

The inflatable protective device 10 of the present invention is preferably designed for protecting motorcyclists. Nevertheless, as it will appear more clearly from the following description, such an inflatable protective device 10 can also be advantageously used by cyclists, skiers, horse riders and the like or in other fields where an effective protection of the user's body must be obtained.

The inflatable protective device 10 comprises an inflatable member 12.

The inflatable member 12 is designed to move between a rest condition, wherein it is in a deflated status, and an operating condition, wherein it is in an inflated status.

The inflatable member 12 can be inflated with a fluid, like for example air or gas, so as to expand for protecting the user of the inflatable protection device 10 against impacts, falls or slides.

Preferably, the inflatable member 12 has a bag-like shape.

Advantageously, the inflatable member 12 can be manufactured by sewing together a lower fabric panel and an upper fabric panel along their perimetric portions, so as to obtain the so-called “sewed” airbag.

Alternatively, the inflatable member 12 can be manufactured by means of a single weaving operation, using for example a Jacquard loom so as to obtain the so-called “one piece woven” (OPW) airbag.

Advantageously, the inflatable member 12 can be manufactured by knitting.

In a further embodiment the inflatable member 12 can be made of an elastic material, preferably chosen in the group comprising natural or synthetic rubbers.

As it is well known in the art, to enhance the deflation of the inflatable member 12 once it has been activated, the inflatable member can be provided with a deflation valve. Alternatively, if the structure of the inflatable member allows a controlled gas leakage, the deflation can take place gradually through the same structure of the member.

For example, if the inflatable member is used in a protective garment for motorcyclists, the deflation can preferably take place in a period of time of 10-20 seconds. Obviously, different deflation times are possible according to specific needs. As schematically shown in FIGS. 1, 2, 21, 23 and 25, the inflatable protective device 10 also comprises an inflator device 14 designed to be coupled to the inflatable member 12 for inflating the latter. In particular, the inflator device 14 has a connecting end 16 designed to be coupled to the inflatable member 12 for putting the inflator device 14 in fluid communication with the inflatable member 12. Advantageously, the connecting end 16 of the inflator device 14 is coupled to an opening end 18 of the inflatable member 12.

In detail, the connecting end 16 is preferably inserted and blocked in a gas-tight manner into the end opening 18 of the inflatable member 12.

As it is known in the art, the connecting end 16 of the inflator device 14 can comprise a connecting cap 20 designed to be fastened at the end opening 18 of the inflatable member 12. Preferably the connecting cap 20 is fastened inside the end opening 18 of the inflatable member 12 by means of a clamp 22 (see for example FIG. 2).

The connecting cap 20 is provided with at least one hole or channel 21. The inflation gas exiting from the inflator device 14 flows inside the inflatable member 12 through said hole or channel 21.

As it is known in the art, the inflator device 14 can be triggered by means of an electrical and/or mechanical activation mechanism.

Preferably the inflator device 14 is chosen from the group comprising pyrotechnic inflators, compressed gas inflators and hybrid inflators.

As it is shown in the enclosed figures, the inflatable protective device 10 also comprises at least one protection sleeve 24.

Said protection sleeve 24 is arranged at the connecting end 16 of the inflator device 14, so as to be interposed between the inflator device 14 and the inflatable member 12.

Preferably, the protection sleeve 24 is arranged between the connecting end 16 of the inflator device 14 and the end opening 18 of the inflatable member 12.

In particular, the protection sleeve 24 has an operative portion 26 extending inside the inflatable member 12 for putting the protection sleeve 24 in fluid communication with the inflatable member 12.

According to the invention, the protection sleeve 24 comprises stiffening means 30 arranged at the operative portion 26. The stiffening means 30 are able to at least partially counter any external pressure acting on said operative portion 26, thereby maintaining in fluid communication the protection sleeve 24 with the inflatable member 12.

As it will appear clearly from the following description, the stiffening means 30 are able to maintain in a condition at least partially open the operative portion 26 so as to permit a quick and effective deflation of the inflatable member 12 when the inflator device 14 needs to be replaced after activation.

Otherwise stated, the stiffening means 30 prevent the operative portion 26 from taking a fully closed condition, whereby the complete deflation of the inflatable member 12 can take place upon replacing the inflator device 14.

In particular, the stiffening means 30 guarantee that, during the replacement of the inflator device 14, the protection sleeve 24 does not act as a non-return valve so as to permit the complete deflation of the inflatable member 12 without particular actions or efforts by the person in charge of the replacement.

As a matter of fact, once the inflator device 14 is removed, the inside part of the inflatable member 12 is put in direct fluid communication through the operative portion 26 stiffened by the stiffening means 30 with the external environment. In case the inflatable member 12 is still swollen, since the gas which is still inside the inflatable member has an absolute pressure higher than the pressure of the external environment, such a gas will spontaneously exit from the inflatable member 12.

This is also valid in case the inflator device 14 comprises a connecting cap 20. In this case, the inside part of the inflatable member 12 is put in fluid communication with the external environment through the hole 21 of the connecting cap 20.

Moreover, the presence of the stiffening means 30 does not hinder the inflation phase of the inflatable member 12, since the stiffening means 30 are also helpful in guaranteeing a fluid communication between the inflatable member 12 and the inflator device 14 during the whole use of the inflatable protective device 10.

With reference to the enclosed figures, the protection sleeve 24 preferably consists in a tube made of a flexible and soft material. In particular, the protection sleeve 24 can be made of a fabric.

Preferably, the protection sleeve 24 is made of the same material of the inflatable member 12.

Advantageously, the protection sleeve 24 can be manufactured by fixing a first sheet 25 of material, for example fabric, and a second sheet of material 27, for example fabric, to each other along their perimetric portions (see for example FIGS. 3-8). The fixing can be carried out by interweaving the threads forming the two sheets 25, 27 or by using a perimeter seam. Alternative methods are well known in the art like for example gluing or heat sealing.

In a further embodiment, the protection sleeve 24 can be formed by a single sheet 28 of material, like for example fabric, having its opposite edges fixed to each other (see for example FIGS. 10 and 11).

The outer surface of the protection sleeve 24 can be covered by a coating, for example, a polymeric coating applied on the outer surface of the sheets 25, 27, 28 for enhancing airtightness and/or mechanical strength.

Alternatively, the protection sleeve 24 can be made of a rigid material, for example a metallic material. In this case, the protection sleeve 24 itself embodies the stiffening means 30. The stiffening means 30 extend thus over the whole length of the protection sleeve 24, not being only limited to the operative portion 26.

Preferably, the protection sleeve 24 has a length between 6 and 18 cm, so as to be arranged at the connection zone between the inflatable member 12 and the inflator device 14, where the gas flow exiting from the inflator device 14 is stressful for the inflatable member 12.

Such a length also assures that even in case of an error in positioning the protection sleeve 24, namely if it is too shifted towards the end opening 18 of the inflatable member 12 or too shifted towards the inflator device 14, the protection sleeve 24 is able to protect the inflatable member 12 against damages.

In a first embodiment of the present invention, schematically shown in FIG. 21, the stiffening means 30 of the protection sleeve 24 consist in a fastener 32 directly connecting the operative portion 26 of the protection sleeve 24 to a surrounding portion of the inflatable member 12.

Preferably, the fastener 32 is provided at a terminal end of the operative portion 26, as “terminal end” of the operative portion being indicated the end of the protection sleeve 24 farther from the connecting end 16 of the inflator device 14.

Such a fastener 32 can consist of a layer of glue interposed between the protection sleeve 24 and the inflatable member 12.

Alternatively, the fastener 32 can consist of a seam arranged at opposite edges of the inflatable member 12 and protection sleeve 24.

In this case, an outer sealing ribbon (not shown in the enclosed figures) can be applied at the outer surface of the inflatable member 12 to assure the airtightness of the connection between the protection sleeve 24 and the inflatable member 12.

With reference now to FIGS. 3-10, if the protection sleeve 24 is formed by a first sheet 25 and a second sheet 27 of material or by a single sheet of material 28, the stiffening means 30 can be advantageously formed by at least one side appendix 34 arranged at a fixing zone between the first sheet 25 and the second sheet 27 or at a fixing zone between opposite edges of the single sheet 28. Said at least one side appendix 34 extends from a tubular body of the protection sleeve. In particular, said at least one side appendix 34 is designed to be folded so as to be interposed between the inflatable member 12 and the inflator device 14. In particular, said side appendix 34 can be interposed between the opening end 18 of the inflatable member 12 and the connecting end 16 of the inflator device 14.

Preferably, when the protection sleeve 24 is formed by two sheets 25, 27 of material, the stiffening means 30 comprise two side appendixes 34. Said appendixes 34 are advantageously provided at opposite edges of the sheets 25, 27 of material so as to extend at opposite directions from the tubular body of the protection sleeve 24.

Advantageously, for being interposed between the inflatable member 12 and the inflator device 14, preferably between the opening end 18 and the connecting end 16, the appendixes 34 can be folded in the same direction, so as to assume a “U-shaped” configuration (see for example FIG. 3) with respect to the tubular body of the protection sleeve 24, or can be folded in opposite directions, so as to assume a “S-shaped” configuration (see for example FIG. 4), with respect to the tubular body of the protection sleeve 24.

The appendixes 34 are maintained in the position shown in FIGS. 3-4 thanks to the fixation between the inflatable member 12 and the inflator device 14, or the connecting cap 20 if present.

Preferably, as it is schematically shown in FIGS. 5-10, a part of said at least one appendix 34 is fastened by means of fastening means to the tubular portion of the protection sleeve 24, so that said at least one appendix 34 at least partially adheres to the tubular portion of the protection sleeve 24.

Said part of the appendix 34 can be fastened to the tubular portion of the protection sleeve 24 by means of seams, glue or similar fastening means.

As it is shown in FIG. 5, in case the appendix is fastened to the tubular portion of the protection sleeve 24 by means of a seam, such a seam can be formed by a single stitching line 36 arranged at the terminal end of the operative portion 26 of the protection sleeve 24.

Alternatively, as it is shown in FIG. 6, said single stitching line 36 can extend for the whole length of the protection sleeve 24.

In a further embodiment, the appendix can be fastened to the tubular portion of the protection sleeve by means of a seam formed by a plurality of stitching lines 38 (see FIGS. 7-10).

The stitching lines 38 can be arranged at the terminal end of the operative portion 26 of the protection sleeve 24 (see FIG. 7) or can extend for the whole length of the protection sleeve 24 (see FIGS. 8-10).

Thanks to a confined fastening of the appendix 34 to the tubular portion of the protection sleeve 24, the appendix 34 forms a sort of loop. Advantageously, in this way the stress exerted by the flow of the inflation gas exiting from the inflator device 14 can be sustained by the tubular portion of the protection sleeve 24 and not exclusively by the stitching lines 36, 38. The risk of breakage of the stitching lines 36, 38 is thus reduced and it is assured that the stiffening means 30 are able to keep at least partially in fluid communication the operative portion 26 with the inflatable member 12.

With reference to FIG. 11 or FIG. 12, if the protection sleeve 24 is formed by a first sheet 25 and a second sheet 27 of material or by a single sheet of material 28, the stiffening means 30 can consist in an overlapping of opposite edges of the first and second sheet 25, 27 or in an overlapping of the opposite edges of the single sheet 28 so as to form a thickening zone 40 in the tubular portion of the protection sleeve 24. Such a thickening zone 40 can have a width preferably between 10 and 20 mm.

The opposite edges of the single sheet material 28 forming the thickening zone 40 can be fastened to each other by means of a single stitching line or by means of a plurality of stitching lines 42, spaced apart to each other (see FIG. 11).

In case the protection sleeve 24 is manufactured by fixing to each other a first sheet 25 and a second sheet 27 of material, the stiffening means 30 can consist in an overlapping of the opposite edges of the sheets 25, 27 so as to form two distinct thickening zones 40 in the tubular portion of the protection sleeve 24.

Also in this case the opposite edges of the sheets 25, 27 forming the thickening zones 40 can be fixed to each other by means of a single stitching line or by means of a plurality of stitching lines 42, spaced apart to each other (see FIG. 12).

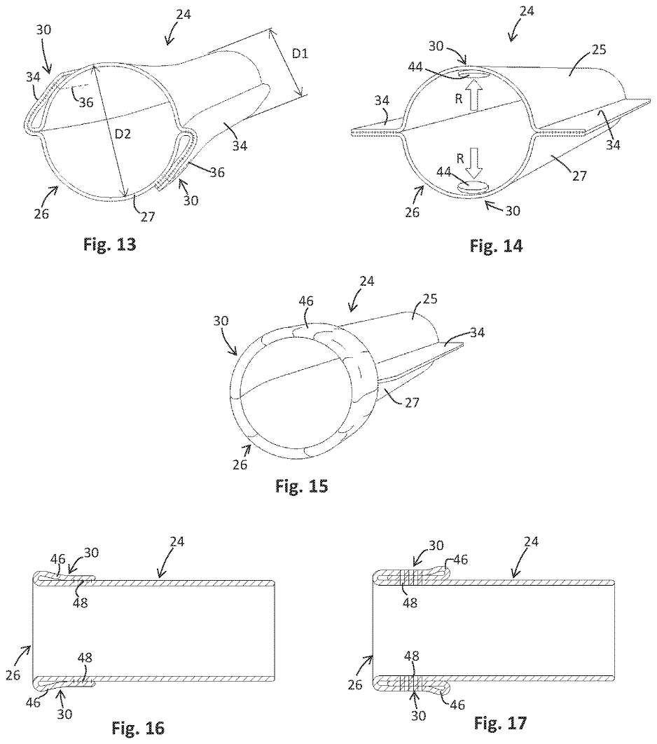

As schematically shown in FIG. 13, the protection sleeve 24 can have a tubular shape having a diameter D2 at the operative portion 26 greater than the diameter D1 of the opposite portion. In other terms, the protection sleeve can have a frustoconical shape, wherein the base is arranged at the operative portion 26.

With reference to FIG. 14, according to a different embodiment of the present invention, the stiffening means 30 can consist of at least two magnets 44, positioned at opposite edges of the operative portion 26.

Said magnets 44 are arranged so as to have like poles, namely the corresponding north poles or the corresponding south poles, to face each other, so that a repelling force can be created at the opposite edges of the operative portion 26 of the protection sleeve 24. Such a repelling force is indicated by the arrows R in FIG. 14.

Advantageously, the magnets 44 can be used in combination with magnets provided at facing portions of the inflatable member 12. In this way, an attractive force can be created between the operative portion 26 and the surrounding zone of the inflatable member 12 by facing to each other magnets having unlike poles.

In a further embodiment, see FIGS. 15-17, the stiffening means 30 consist of a rolled rim 46 provided at the terminal end of the operative portion 26 of the protection sleeve 24. Such a rolled rim can be obtained by folding the operative portion 26 of the protection sleeve 24 on itself.

The operative portion 26 can be folded on itself one time (see FIG. 16) or more than one time (see FIG. 17) so as to form a thicker border 46 whose stiffness makes the closure of the operative portion 26 more difficult.

The rolled rim 46 can be blocked on the tubular portion of the protection sleeve 24 by means of fastening means 48, like for example a seam.

Advantageously, the stiffening means 30 can also comprise a rigid element 50 having an open shape; said rigid element being fitted at the operative portion 26 of the protection sleeve 24.

Preferably, such a rigid element 50 has a circular shape (see FIGS. 18 and 19).

Advantageously, the rigid element 50 can be applied at the inner surface of the operative portion 26 (see FIG. 18) or, alternatively, at the outer surface of the operative portion 26 (see FIG. 19). If the rigid element 50 is applied at the outer surface of the operative portion 26, a glue layer is preferably interposed between the operative portion 26 and the rigid element 50 so as to assure that the operative portion stays adherent to the rigid element 50.

In a further embodiment, the rigid element 50 can have a cross shape (see for example FIG. 20) or a different shape, for example a star shape.

Preferably, the ends of the arms of the rigid element 50 having a cross shape are fastened inside the operative portion 26 by means of blocking means 52, for example glue layers.

The rigid element 50 can be made of a metallic material or rigid polymeric material.

In an alternative embodiment, the stiffening means 30 comprise an additional protection sleeve 54 which is concentrically arranged around the protection sleeve 24. Preferably, the protection sleeve 24 is fastened to the additional protection sleeve 54 at the operative portion 26. In this way, the combination of the two protection sleeves assures a higher stiffness.

The addition of a further protection sleeve 54 can take place also in case the inner protection sleeve 24 is provided with one or more of the other stiffening means previously disclosed.

In FIG. 22 it is shown, for example, the combination of a protection sleeve 24, provided with two appendixes 34, with an outer protection sleeve 54.

Advantageously, more than one additional protection sleeve 54 can be applied at the outer surface of the inner protection sleeve 24 directly connected to the inflator device 14.

In a further embodiment, see FIGS. 24 and 25, the protection sleeve 24 can be integral with the inflatable member 12. In this way, the protection sleeve 24 and the inflatable member 12 are a single element.

In particular, the protection sleeve consists of a folded portion of the inflatable member 12, provided at an opening end 18 of the inflatable member 12.

The connecting end 16 of the inflator device is coupled to the inflatable member 12 by inserting it inside the folded portion of the inflatable member, which thus also acts as a protection sleeve. The gas-tight connection between inflator device and inflatable member is obtained by fastening a clamp 22 around the folded opening end 18 of the inflatable member 12.

As shown in FIGS. 24 and 25, the inflatable member 12 is preferably folded inward at the opening end 18 along a folding line 60, so that the folded portion realizes the protection sleeve 24.

As visible in FIGS. 24 and 25, in case the inflatable member 12 is formed by a first material 25A and a second material 27A, which are fixed to each other along side outer perimetric portions 34A, such perimetric portions 34A will form the stiffening means 30 of the protection sleeve 24, once the inflatable member is folded along the folding line 60.

In particular, the stiffening means 30 will be formed by the appendixes 34 which, after the folding of the inflatable member, are directly facing the inflator device 14.

In case the inflatable member 12 is formed by a first material 25A and a second material 27A, which are fixed to each other along side inner perimetric portions, also such perimetric portions will form the stiffening means of the protection sleeve.

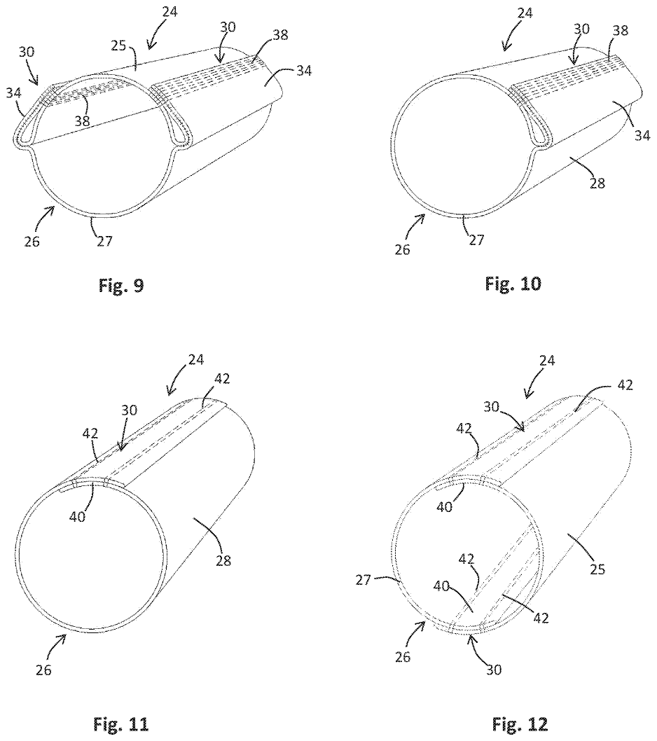

Differently from the previous embodiment, in this case the appendixes, after the folding of the inflatable member, will be arranged at the external side of the protection sleeve, in a situation similar to that shown in FIG. 3 or 9.

In other words, the appendix will be interposed between the protection sleeve and the outer portion of the inflatable member.

Preferably, in order to make the folding of the inflatable member easier, the diameter of the part of the inflatable member acting as protection sleeve will be smaller than the diameter of the remaining part of the inflatable member.

In this way, the formation of wrinkles along the folding line 60 is avoided. Moreover, the folding operation is made easier.

The embodiment wherein the protection sleeve, with stiffening means, and the inflatable member are a single element is advantageous since there is no further need of manufacturing a separated protection sleeve.

Moreover, all the embodiments disclosed with reference to a protection sleeve separated from the inflatable member, see for example FIGS. 2-23, can also be applied to the embodiment wherein the inflatable member and the protection sleeve are a single element.

As previously anticipated, the present invention also relates to a method for effectively deflating an inflatable protective device after the inflation.

The method comprises the following steps:
providing an inflatable protective device comprising:
an inflatable member 12 designed to move between a rest condition, wherein it is in a deflated status, and an operating condition, wherein it is in an inflated status;
an inflator device 14 designed to be coupled with a connecting end 16 to the inflatable member 12 for inflating the inflatable member 12;
at least one protection sleeve 24 arranged at the connecting end 16 of the inflator device 14, so as to be interposed between the connecting end 16 of the inflator device 14 and the inflatable member 12; the protection sleeve 24 having an operative portion 26 extending inside the inflatable member 12 for putting the protection sleeve 24 in fluid communication with the inflatable member 12

The method is characterized by comprising the step of at least partially countering any external pressure acting on the operative portion 26 of the protection sleeve so as to maintain in fluid communication the protection sleeve 24 with the inflatable member 12.

The countering step is carried out by providing the protection sleeve 24 with stiffening means 30 at the operative portion 26 so as to keep at least partially open the operative portion 26 thereby permitting the deflation of the inflatable member 12 when the inflator device 14 is decoupled from the inflatable member.

It is clear now how the present invention allows to achieve the predefined objects.

As a matter of fact, thanks to the provision of the stiffening means, the inflatable bag can be effectively deflated when the inflator device is decoupled from the inflatable member in case it needs to be replaced after activation.

In particular, the confidence that the inflatable member is completely deflated once the exhaust inflator device is decoupled from the inflatable member permits that such an operation can also be carried by the final user and not exclusively by trained personnel of dedicated customer services.

Moreover, the addition of the stiffening means does not render more complex the structure of the protective device and does not affect the airtightness between the inflator device and the inflatable member.

With regard to the embodiments of the inflatable protective device described above, the person skilled in the art may, in order to satisfy specific requirements, make modifications to and/or replace elements described with equivalent elements, without thereby departing from the scope of the accompanying claims.

For example, it is possible to combine one or more embodiments to each other. In particular, the fastener between the protection sleeve and the inflatable member can be used in combination with the side appendixes properly folded or with the rigid element applied at the outer or inner surface of the protective sleeve.

1. An inflatable protective device comprising:
an inflatable member designed to move between a rest condition wherein a deflated status and an operating condition wherein an inflated status;
an inflator device designed to be coupled to the inflatable member for inflating the inflatable member, said inflator device having a connecting end designed to be coupled to said inflatable member;
at least one protection sleeve arranged at the connecting end of the inflator device so as to be interposed between the connecting end of the inflator device and the inflatable member, said at least one protection sleeve having an operative portion extending inside the inflatable member for putting the at least one protection sleeve in fluid communication with the inflatable member;
wherein said at least one protection sleeve comprises stiffening means arranged at said operative portion, said stiffening means being able to at least partially counter any external pressure acting on said operative portion, thereby maintaining in fluid communication the at least one protection sleeve with the inflatable member.

2. The inflatable protective device according to claim 1, characterized in that said stiffening means consist in a fastener directly connecting the operative portion of the at least one protection sleeve to a surrounding portion of the inflatable member.

3. : The inflatable protective device according to claim 2, characterized in that said fastener is provided at a terminal end of the operative portion.

4. The inflatable protective device according to claim 1, characterized in that said at least one protection sleeve is formed by a first sheet and a second sheet of material or by a single sheet of material, wherein the stiffening means are formed by at least one side appendix arranged at a fixing zone between the first sheet and the second sheet of material or at a fixing zone between opposite edges of the single sheet.

5. The inflatable protective device according to claim 4, characterized in that said at least one appendix extends from a tubular body of said at least one protection sleeve, said at least one appendix being designed to be folded so as to be interposed between an opening end of the inflatable member and the connecting end of the inflator device.

6. The inflatable protective device according to claim 4, characterized in that, when said at least one protection sleeve is formed by a first sheet and a second sheet of material, the stiffening means comprise two side appendixes, said side appendixes being provided at opposite edges of the sheets of material so as to extend at opposite directions from a tubular body of the at least one protection sleeve.

7. (canceled)

8. The inflatable protective device according to claim 4, characterized in that a part of said at least one appendix is fastened by means of fastening means to a tubular portion of said at least one protective sleeve, so that said at least one appendix at least partially adheres to the tubular portion of said at least one protection sleeve.

9-10. (canceled)

11. The inflatable protective device according to claim 1, characterized in that said at least one protection sleeve is formed by a first sheet and a second sheet of material or by a single sheet of material, the stiffening means consisting in an overlapping of the opposite edges of the first sheet and second sheet or in an overlapping of the opposite edges of the single sheet so as to form at least one thickening zone in the tubular portion of said at least one protection sleeve.

12. (canceled)

13. The inflatable protective device according to claim 1, characterized in that the stiffening means consist of at least two magnets positioned at opposite edges of the operative portion, said at least two magnets being arranged so as to have like poles to face each other so that a repelling force is created at the opposite edges of the operative portion.

14. The inflatable protective device according to claim 1, characterized in that the stiffening means consist of a rolled rim provided at a terminal end of the operative portion, said rolled rim being obtained by folding the operative portion of the at least protection sleeve on itself.

15. The inflatable protective device according to claim 14, characterized in that the operative portion is folded on itself one time or more than one time so as to form a thicker border.

16. The inflatable protective device according to claim 14, characterized in that the rolled rim is blocked on the tubular portion of the protection sleeve by means of fastening means.

17. The inflatable protective device according to claim 1, characterized in that the stiffening means comprise at least one rigid element having an open shape, said at least one rigid element being fitted at the operative portion of the at least one protection sleeve.

18. (canceled)

19. The inflatable protective device according to claim 1, characterized in that the stiffening means comprise at least one additional protection sleeve concentrically arranged outside said at least one protection sleeve.

20. The inflatable protective device according to claim 19, characterized in that said at least one protection sleeve is fastened to said at least one additional protection sleeve at the operative portion.

21. The inflatable protective device according to claim 1, characterized in that said at least one protection sleeve is made of a rigid material. said at least one protection sleeve embodying itself the stiffening means which extend over a whole length of the at least one protection sleeve.

22. The inflatable protective device according to claim 1, characterized in that said at least one protection sleeve is integral with the inflatable member forming a single element.

23. The inflatable protective device according to claim 22, characterized in that said at least one protection sleeve consists of a folded portion of the inflatable member provided at an opening end of the inflatable member.

24. A wearable protective device comprising an inflatable protective device according to claim 1.

25. A method for effectively deflating an inflatable protective device after inflation, the method comprises the following steps:
providing an inflatable protective device comprising:
an inflatable member designed to move between a rest condition, wherein it is in a deflated status, and an operating condition, wherein it is in an inflated status;
an inflator device designed to be coupled with a connecting end to the inflatable member for inflating the inflatable member;
at least one protection sleeve arranged at the connecting end of the inflator device, so as to be interposed between the connecting end of the inflator device and the inflatable member, said at least one protection sleeve having an operative portion extending inside the inflatable member for putting said at least one protection sleeve in fluid communication with the inflatable member;
at least partially countering any external pressure acting on the operative portion of the at least one protection sleeve for maintaining in fluid communication the at least one protection sleeve with the inflatable member, said countering step being carried out by providing the at least one protection sleeve with stiffening means at the operative portion so as to keep at least partially open the operative portion, thereby permitting the deflation of the inflatable member when the inflator device is decoupled from the inflatable member.
